(19) United States
(12) Patent Application Publication
(10) Pub. No.: US 2009/0099814 A1
(43) Pub. Date: Apr. 16, 2009

(54) System for monitoring the efficiency of an hvac system

(76) Inventor: Charles F. Scott, Gallipolis, OH (US)

Correspondence Address: HOFFMAN, WASSON & GITLER, P.C., Suite 522, 2461 South Clark Street, Arlington, VA, 22202, US

(21) Appl. No.: 12/285,490

(22) Filed: Oct. 7, 2008

Related U.S. Application Data
(60) Provisional application No. 60/960,718, filed on Oct. 11, 2007.

(51) Int. Cl. G04F 10/00; G08B 5/00

(52) U.S. Cl. 702/178; 340/691.6

(57) ABSTRACT

The present invention is directed to a system for recording the run time or off time of a heating ventilation and air conditioning (HVAC) system. A sensor would sense when the HVAC system is operating or is not operating. This information is transmitted to a receiver for displaying the run time or off time. The sensor could be directly wired to the receiver or could operate in a “wireless” mode in which the sensor is connected to a transmitter which would utilize radio frequency signals to transmit information to the receiver. The receiver is provided with a display in memory for specifically displaying the run time or off time of the HVAC unit.

### CROSS-REFERENCE TO RELATED APPLICATIONS

This application claims the benefit of U.S. Provisional Patent Application Ser. No. 60/960,718, filed Oct. 11, 2007.

### FIELD OF THE INVENTION

The present is directed to a system for monitoring the efficiency of a heating/ventilation/air conditioning (HVAC) system.

### BACKGROUND OF THE INVENTION

It is certainly true that at the present time the cost of producing energy is increasing at a rate which appears to be either geometrically or exponentially. Therefore, it is quite important that consumers be able to monitor the amount of energy that they use to heat or cool individual houses as well as places of business. It is certainly true that the less time a heating or air conditioning system is operating to heat or cool a particular environment, the lower cost to the consumer would be realized to produce the desired result.

Consequently, by utilizing the experience of “inside information” relating to the exact time a furnace or air conditioning unit has been operating, or, alternatively, the time the furnace and the air conditioning unit have not been operating, and changing the usage of the furnace and air conditioning system based upon this information, a savings can be immediately realized. Unfortunately, present day systems, while indicating when an air conditioning system or furnace is operating, the exact time of operation is not calculated and maintained with respect to the thermostat used to control the operation of these systems. Therefore, if the exact time that the systems would operate would be relayed to the individual consumer, the consumer would have the ability of altering various conditions, thereby more efficiently operating the air conditioning unit or the furnace. For example, the thermostat could be raised in the summer to lessen the amount of time the air conditioning unit was operating or, in the winter, the thermostat could be lowered, thereby reducing the amount of time that the furnace has been operating. Additionally, the consumer could utilize this information to more efficiently insulate the environment of use, for instance, by better insulating cracks in doors, windows and the ceiling. Additionally, the consumer could close various air ducts in particular rooms which are unoccupied, thereby also increasing an energy savings and reducing the ultimate cost to the consumer of electricity and gas. Additional savings could be realized if alternate or additional sources of heating or cooling would be employed by the consumer.

### SUMMARY OF THE INVENTION

These and other problems associated with the prior art are rectified by the present invention which utilizes a display for monitoring the run time or off time of a heating/cooling unit. The operation of the heating/cooling unit is indirectly measured by sensing the air flow through a particular duct. In a “wired” embodiment, an air sensor is directly connected to a display unit which would continuously update the display showing the present run time or off time of the unit. Once the run time or off time of a heating or cooling cycle has been completed, the display would maintain the total run time of the previous cycle. This run time and off time could be maintained in a memory associated with the display unit, thereby maintaining the total run time or off time of the unit through a plurality of cycles as well as maintaining the run time or off time of each cycle. Additionally, since the run time or off time of a particular cycle is maintained on the display, until at least the next cycle is initiated, the individual can make note of the total run times or off times of various cycles by recording the run time or off time of each cycle on a chart.

This information can be used to determine whether the heating and cooling system is efficient enough to heat or cool a unit at a certain thermostatic setting with the amount of insulation surrounding the unit or provided within the environment of the unit. The insulation can be changed by better insulating various cracks in windows, doors and ceilings and floors.

A second embodiment of the present invention would include a display unit acting as a receiver, wirelessly connected to a transmitter which is in turn connected to the air sensor. The transmitter would send a signal to the receiver at a predetermined frequency, such as once a minute, once an hour, etc. When the receiver receives a signal, a logic circuit provided therein would add one digit to the digital display, depending upon the type of units utilized, such as minutes or hours. A capacitor and resistor arrangement in the circuit would reset the system when appropriate.

These and other objects and features of the present invention will become more fully apparent from the following description and appended claims taken in conjunction with the accompanying drawings.

### BRIEF DESCRIPTION OF THE DRAWINGS

FIG. 1 illustrates the receiver of the present invention;

FIG. 2 illustrates the transmitter of the present invention;

FIG. 3 shows an air sensor with the HVAC system in the off condition;

FIG. 4 illustrates the air sensor with the HVAC system operating; and

FIG. 5 illustrates a worksheet which can be utilized with the present invention.

### DETAILED DESCRIPTION OF THE PRESENT INVENTION

The present invention is directed to a system in which a record is kept of the total time as well as the incremental run time or offtime of an HVAC system. This is accomplished by sensing when the HVAC system is operating or not operating. This information is then transmitted to a receiver which would record the run time or off time when the system is operating either in the heating or cooling mode. This run time or off time is maintained in the memory of the receiver as well as can be physically recorded on a record sheet.

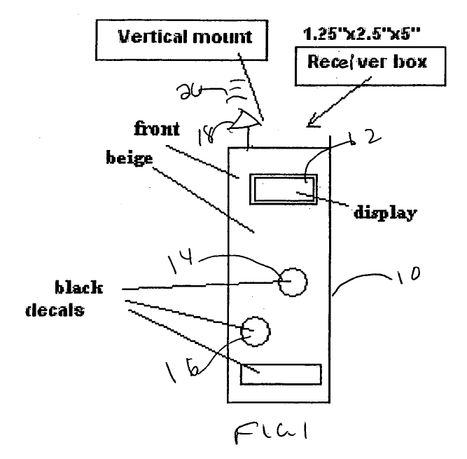

FIG. 1 illustrates a receiver 10 for recording the run time, or in a second embodiment, the off time of the HVAC system. In one embodiment, the receiver 10 can be wired directly to an air sensor used in the HVAC system itself to determine when the HVAC system is operating.

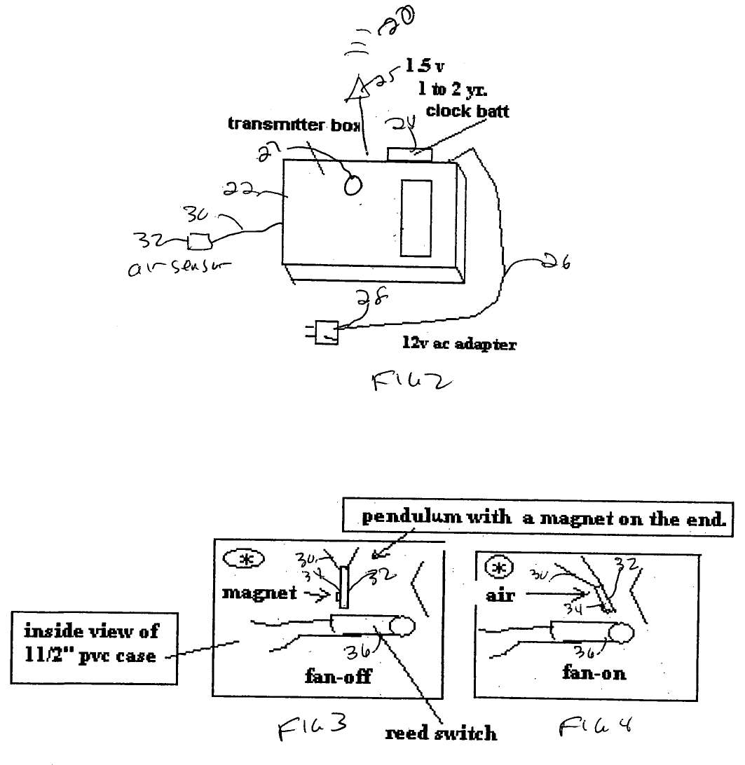

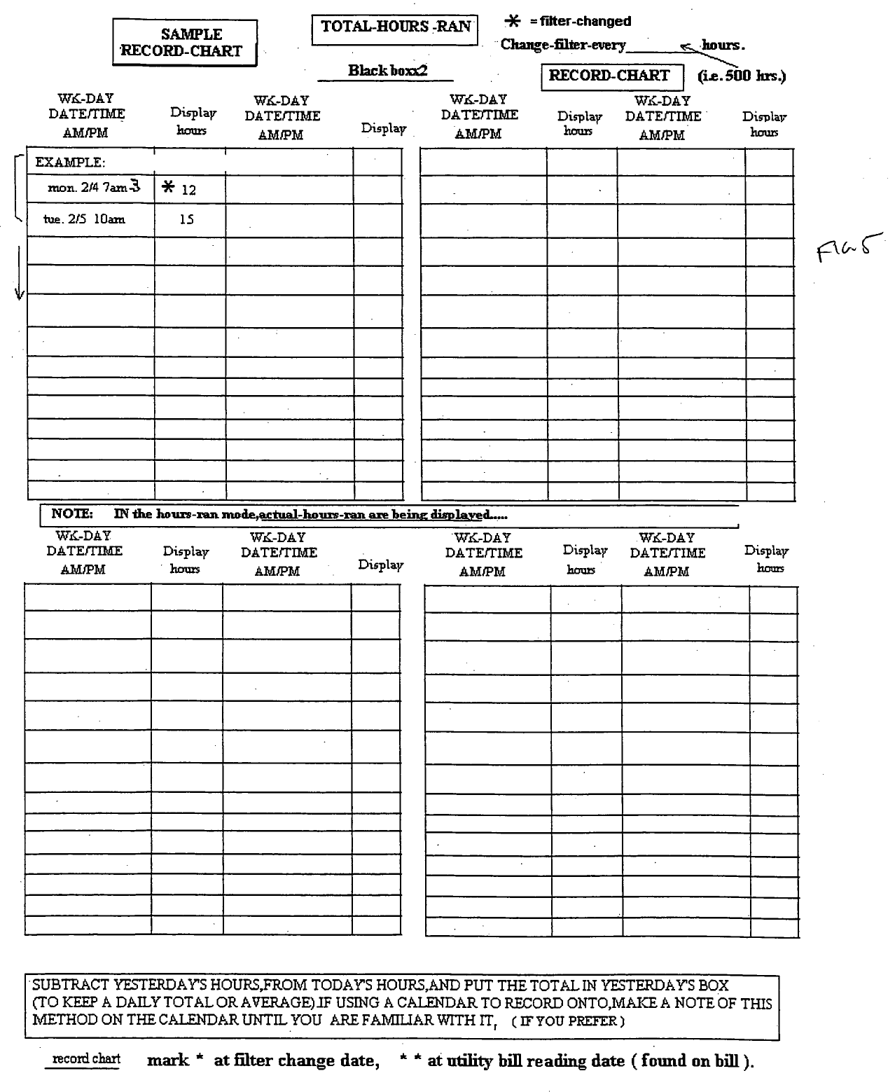

Another embodiment of the present invention would wirelessly determine when the system is either on or off. In this wireless embodiment, a transmitter box 22 would transmit information directly to the receiver 10 indicating the operating condition of the HVAC system, i.e. when that system is on or off regardless of whether the system is in the heating or cooling mode. In the embodiment shown in FIGS. 2, 3 and 4, the condition of the system would be determined by the use of an air sensor 32 connected to the transmitter box 22 through the use of a wire 30. The air sensor 32 can be provided immediately adjacent to a heating and cooling register or can be provided within a sensor box as shown in FIGS. 3 and 4. When it has been determined that the system is operating through the utilization of the air sensor 32, the transmitter box 22 would transmit from an antenna 25, a radio frequency signal 20 directed to an antenna 18 connected to the receiver 10.

In one embodiment, a first signal would be transmitted from the transmitter box 22 to the receiver 10 when the HVAC system begins to operate and a second signal is transmitted from the transmitter box 22 to the display 10 which contains an internal clock when the HVAC system ceases to operate. During the interval between the transmission of the first signal and the second signal, a display 12 provided on the face of the receiver 10 would constantly be incremented and the display would show the amount of time that the system is operated in hours and minutes. In a second embodiment, the transmitter box 22 would constantly transmit a signal during the operating time or non-operating time of the HVAC system, at which time the display 12 would be constantly incremented upward until the antenna 25 ceases to transmit a signal to the receiver 10 indicating that the system is not operating. A memory is provided within the receiver 10 which would maintain all the operating times for at least a predetermined period of time during the operation of the HVAC system. This period of time could be days, months or years depending upon the type of logic and memory provided within the receiver 10. Furthermore, as previously indicated, the display 12 as well as the memory provided within the receiver 10 would alternatively record the “off” times of the HVAC system.

The receiver 10 would include various control devices on its surface such as input devices 14 and 16. For example, input device 14 could be utilized to display various operating “on” and “off” times recorded in the receiver's memory to be utilized by the consumer or recorded on the display sheet shown in FIG. 5.

When operating in the wireless mode between the receiver 10 and the transmitter 22, these devices must be in radio communication with one another and should be separated from one another by a finite distance such as 10-150 feet. It is important that the radio communications between the receiver 10 and the transmitter 22 should be maintained without any interference from other appliances or electrical devices. Consequently, the radio frequency signal transmitted from the transmitter box 22 can be altered through the use of a control knob or similar device 27. The receiver 10 is provided with a dial 16 which could be utilized to change the frequency of the signal received by the receiver 10.

Both the receiver 10 and the transmitter 22 can be operated through the use of one or more batteries. Alternatively, the transmitter 22 would include a 12 volt AC adapter 28 connected to the transmitter box 22 by a standard wire 26 and can be used as an alternative power source.

FIGS. 3 and 4 illustrate just one manner in which the operation of the HVAC system is determined. As shown in FIG. 3, the air sensor 32 consists of a movable flap provided with a magnet 34 attached to one face. FIG. 3 shows the flap in the condition when the HVAC system is not operating. This sensor is connected to a wire 30 attached to the transmitter box 22. When the HVAC system is operating as illustrated in FIG. 4, the flap 32 would move and a reed switch 36 in conjunction with the magnet 34 would produce a signal which in turn is transmitted over the wire 30 to the transmitter box 22, indicating that the HVAC system is properly operating.

FIG. 5 illustrates a sample record chart in which the dates and times that the system has been operating either in the on or off mode has been recorded. The consumer would utilize this system to change various operating conditions in a particular environment such as the consumer's home. In this situation, the consumer would make various changes to the environment such as better insulating the ceilings of the environment as well as plugging cracks in the environment's windows and doors. Alternatively, the consumer could close off various rooms from heating and cooling by closing the various vents provided in that particular room. The consumer can then notice the change in operating time. Additionally, the consumer would also have the ability to raise the thermostat's temperature during warmer months as well as lowering the thermostat's temperature during cooler months to provide energy savings.

The installation of the wireless system will not be explained. With the transmitter 22 positioned in an area away from metal devices, the HVAC unit fan is turned on and the transmitter clock begins to run. The receiver 10 is also positioned away from metallic surroundings and electric motors and is within the transmitter range. The fact that it is within transmittal range would be shown by the display 12 operating or flashing. If it appears that the display 12 of the receiver 10 is operating correctly, both the receiver 10 and the transmitter 12 should be permanently affixed to their respective locations. The present invention including the display 12 of the transmitter 10 would be automatically reset at 0 at startup of a heating or cooling cycle. Additionally, as previously indicated, the present invention can monitor the off time of the unit as well as the on time. When the unit is operating in the “off time”, the reed switch of the air sensor can be positioned to cause the clock provided within the receiver 10 to operate when the fan is off and to stop when the fan of the HVAC system begins to operate. When monitoring the “off time” embodiment of the present invention, the display 12 would still reset to 0 at the appropriate time. When the user looks at the “off time” display, and the HVAC unit fan is running, the user is seeing how long the furnace or air conditioner was off during the last shut down period.

During the summer, if it is, for example, 90° outside, and the display on the monitor 12 indicated 35 and it was not being incremented, this would mean that the air conditioner unit has stopped running and it took 35 minutes for the unit to cool down your home enough to satisfy the present wall thermostat setting. The run time of this air conditioning unit can be changed which in turn would lower the consumer's bill and energy use, by closing off unused rooms or adding insulation, or by increasing the temperature level of the thermostat one or two degrees to make the HVAC unit run more efficiently in less run time.

During winter, if, for example, it was 15° outside and the display of the monitor showed 120 and was not flashing, this would mean that the heating unit has stopped running and it took 120 minutes (two hours) for the unit to heat the home enough to satisfy the consumer's present thermostat setting. This can be altered and your energy bill lowered by again, closing off unused rooms, or adding insulation or turning the thermostat down a degree or two to make the heating unit run more efficiently.

In one embodiment, the system would automatically reset each time the heating or cooling system would begin operating. This would allow the user to monitor and compare various cycle run times by noting each particular run time on the chart shown in FIG. 5. If the user was not able to physically record each run time prior to the initiation of a second run time, utilizing the memory capability of the receiver 10 along with an input device such as button 14 would allow the display 12 to show all of the run times for a particular period of time.

The present invention would also operate by preventing the display 12 to be automatically reset. This would be accomplished by utilizing a function magnet in conjunction with the receiver to change the operating mode of the receiver 10 from operating in the auto reset mode to a mode in which the display is not reset. Additionally, various controls such as dial or button 14 can be utilized for this purpose.

While the above-detailed description is shown, described or pointed out the novel features of the invention as applied to various embodiments, it will be understood that various omissions and substitutions and changes in the form and details of the device may be made by those skilled in the art, without departing from the spirit of the invention.

What is claimed is:

1. A system for monitoring the operating efficiency of an HVAC system including a fan, comprising:
a sensor for sensing first and second operating states of the fan, said sensor producing a first signal when said first state is initiated and a second signal when said first state ceases; and
a receiver receiving said first and second signals produced by said sensor, said receiver provided with a clock and a display for displaying at least one run time of said first state of the fan based upon the receipt of said first and second signals.

2. The system in accordance with claim 1, wherein said sensor produces a third signal when said second state is initiated and a fourth signal when said second state ceases and further wherein said receiver displays at least one run time of said second state of the fan based upon the receipt of said third and fourth signals.

3. The system in accordance with claim 1, wherein said sensor is a reed switch sensing the flow of air produced by the fan.

4. The system in accordance with claim 1, wherein said first operating state occurs when the fan is operating.

5. The system in accordance with claim 2, wherein said second operating state occurs when the fan is not operating.

6. The system in accordance with claim 1, further including a transmitter directly connected to said sensor, said transmitter provided with a first antenna producing radio frequency signals based upon the position of said sensor, and further wherein said receiver is provided with a second antenna receiving said radio frequency signals produced by said transmitter.

7. The system in accordance with claim 2, further including a transmitter directly connected to said sensor, said transmitter provided with a first antenna producing radio frequency signals based upon the position of said sensor, and further wherein said receiver is provided with a second antenna receiving said radio frequency signals produced by said transmitter.

8. The system in accordance with claim 7, wherein said sensor produces first additional signals between said first and second signals, said first additional signals received by said receiver.

9. The system in accordance with claim 7, wherein said sensor produces second additional signals between said third and fourth signals, said second additional signals received by said receiver.
